(19) United States
(12) Patent Application Publication
(10) Pub. No.: US 2009/0144483 A1
(43) Pub. Date: Jun. 4, 2009

(54) DISK ACCESS SYSTEM SWITCHING DEVICE

(75) Inventors: Tatsuya SAKURAI, Kawasaki (JP); Satoru Sankoda, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/325,203

(22) Filed: Nov. 30, 2008

(30) Foreign Application Priority Data
Nov. 30, 2007 (JP) 2007-311097

(51) Int. Cl. G06F 12/00; G06F 9/455

(52) U.S. Cl. 711/100; 718/1; 711/E12.001

(57) ABSTRACT

A disk access system switching device is interposed between a first driver accessing an OS boot disk by use of a first disk access system, a second driver accessing by use of a second disk access system capable of accessing the disk faster than by the first disk access system, and a high-order driver issuing disk access commands to the first and second drivers, wherein the disk access command received from the high-order driver with respect to the boot disk directed to the first driver is transferred to the first driver before an end of initializing the second driver, and the disk access command received from the high-order driver with respect to the boot disk directed to the first driver is transferred to the second driver when detecting the end of initialization of the second driver.

This application claims the benefit of Japanese Patent Application No. 2007-311097 filed on Nov. 30, 2007 in the Japan Patent Office, the disclosure of which is herein incorporated in its entirety by reference.

### BACKGROUND

1. Technical Field

The present invention relates to a disk access system switching device switching over, in an virtual OS (Operating System) environment, a disk access system from a first disk access system such as an I/O emulation system to a second disk access system such as a Para-Virtualization system.

2. Description of the Related Art

Xen (provided by XenSource Inc.) is given as one piece of virtualization software that virtualizes a computer and enables a plurality of Operating Systems (OS) to simultaneously operate in parallel. The Xen is one piece of software called a Virtual Machine Monitor (VMM). The Xen manages batchwise hardware resources of the computer, and can behave as a virtual computer called a Virtual Machine (VM) combined with a part of the OS with respect to the OS.

In the virtual OS environment (Xen-based platform), a management OS (domain 0) for managing a guest OS exists, and the guest OS operates under the management thereof. The boot disk of the guest OS is perfectly virtualized and perfectly emulated with actually-existing hardware (H/W) (I/O (Input/Output) emulation system). An I/O access system based on this I/O emulation system is low in its performance and low especially in performance of an I/O access.

Such being the case, in order to improve the I/O performance of the disk, there is a para virtualization (ParaVirtualization: PV) system for configuring the virtual H/W (virtual machine) convenient for virtualization without perfectly emulating the actually-existing hardware (H/W) by way of semi-virtualization. The performance can be enhanced by executing the I/O access via this virtual H/W interface. The I/O access based on the semi-virtualization entails using a dedicated device driver.

FIG. 8 conceptually illustrates the guest OS using the I/O emulation system and the PV system as the disk access systems, respectively. In FIG. 8, a guest OS 40A includes an ATAPI/IDE standard driver 41 for performing the disk access based on the I/O emulation system, a virtual SCSI driver 42 for conducting the disk access based the PV system, and a disk class driver 43 for supplying a variety of commands containing a disk I/O command (disk input (write)/output (read) command) to the drivers 41 and 42.

The I/O emulation system enables the guest OS 40A to access the physical disk 12A through the management OS 20 by accessing the H/W (virtual ATAPI/IDE H/W 31 in FIG. 8) emulated via an Xen Hypervisor 30. The PV system enables the guest OS 40A to access the physical disk 12A through the ATAPI/IDE standard driver 21 of the management OS 20 by accessing a semi-virtualization disk driver (virtual SCSI driver 23) of the management OS 20 via the Xen Hypervisor 30 from the semi-virtualization disk driver (driver 42). The disks based on these two systems are independent, and a disk sharing the two systems does not exist.

Herein, the domain 0 (management OS) is defined as an OS which manages another guest OS via the Xen Hypervisor. The domain 0 is interposed between the guest OS and the H/W (e.g., the physical disk 12A), and is thereby enabled to virtually generate the H/W and to associate the virtual H/W with the real H/W. The domain 0 (management OS), the real H/W being concealed by the Xen Hypervisor, allocates (assigns) the virtual H/W (virtual machine) to a domain 1 (the guest OS).

In the Xen-based platform, at least one of the two systems such as the I/O emulation system and the PV (ParaVirtualization) system can be utilized as a system for performing the disk I/O. In the I/O emulation system, the Xen Hypervisor emulates the hardware of the ATAPI (AT Attachment Packet Interface) and IDE (Integrated Drive Electronics) as actually-existing hardware (H/W) circulating in the general public. The guest OS executes an I/O command by utilizing the emulated virtual H/W (e.g., the virtual ATAPI/IDE/W31 in FIG. 8). Therefore, the device driver (corresponding to, e.g., the ATAPI/IDE standard driver 41 in FIG. 8) for the actually-existing H/W circulating in the general public can be used intactly as the device driver employed in the virtual OS (corresponding to the guest OS 40A in FIG. 8). An I/O request for the virtual H/W is controlled from the management OS 20 and converted into an I/O request for the physical disk 12A by an I/O emulator 22 on the management OS 20. The I/O emulation system can be utilized for the boot disk (which is generally a C-drive) of the guest OS such as Windows (registered trade mark), and has, on the other side, a demerit of having a high performance load caused by emulation of the H/W.

On the other hand, in the PV system, the guest OS 40A and the management OS 20 have the PV system based device drivers (virtual disk drivers 42 and 23) respectively, and these device drivers are paired to process the I/O request while performing cooperative operations, then convert this I/O request into the I/O request for the physical disk 12A, and transfer the I/O request to the ATAPI/IDE standard driver 21 as the device driver for the physical disk 12A. With this scheme, the driver 21 performs the disk access to the physical disk 12A.

The PV system based device driver (corresponding to the virtual SCSI driver 42) held by the guest OS is called a front-end driver, while the PV system based device driver (corresponding to the virtual SCSI driver 23) held by the management OS is called a backend driver.

In the PV system, the actually-existing hardware is not emulated as by the I/O emulation system, and simply the I/O data is transferred and received by use of a shared memory accessible from both of the guest OS and the management OS. The I/O data process is thereby simplified. The reception and the transfer of the I/O data are attained by the cooperative operations of the front-end driver and the backend driver. The PV system exhibits the higher I/O request performance than by the I/O emulation system. On the other hand, if Windows (registered trade mark) is applied as the guest OS, when in a boot (startup) process of this guest OS, timing at which the PV system based driver (virtual SCSI driver 42) is loaded is later than that of the I/O emulation system base driver (ATAPI/IDE standard driver 41), and hence there is a demerit of being unable to be adopted as the disk access system for the boot disk (Boot Disk) of the guest OS.

Namely, at an early stage of the boot process of the guest OS such as Windows (registered trade mark), the device driver (ATAPI/IDE standard driver 41) of the I/O emulation system based disk is loaded first, and the PV system based device driver (virtual SCSI driver 42) is loaded at a later stage of the boot process. At the early stage of the boot process, there occurs the I/O request for the boot disk stored with the system file containing boot data. In a status where the PV system based driver is not yet completely loaded, the I/O request-enabled disk is only the disk based on the I/O emulation system. Further, the access to the boot disk including the existence of (stored with) the system file is carried out mainly with the following triggers. Therefore, an access frequency to the boot disk is high.
(1) Loading/unloading of the system file.
(2) Writing a log file for the system.
(3) Access to a registry.
(4) Swap with the virtual memory file.
(5) Output to a memory dump

[Patent document 1] Japanese Patent Laid-Open Publication

[Patent document 2] Japanese Patent Laid-Open Publication

### SUMMARY OF THE INVENTION

If the boot disk is based on the I/O emulation system, the following problems in terms of the performance arise.
(a) A considerable period of time is expended for booting the system.
(b) After booting, the performance for the normal operation comparatively decreases.
(c) The performance of the output to the memory dump is low. A tremendous amount of time is expended for outputting the dump when the system is crashed down, resulting in a factor of hindrance against an early recovery of the system.

It is an object of the present invention, which was devised in view of the problems given above, to provide a technology capable of speeding up a disk access to a boot disk.

A mode of the present invention adopts the following configurations in order to solve the problems given above. Namely, a disk access system switching device, according to the present invention, interposed between a first driver executing a disk access to an operating system boot disk by use of a first disk access system, a second driver executing the disk access by use of a second disk access system capable of the disk access faster than by the first disk access system, and a high-order driver issuing disk access commands to the first and second drivers, wherein the disk access system switching device transfers the disk access command received from the high-order driver with respect to the boot disk directed to the first driver to the first driver before an end of initializing the second driver, and transfers the disk access command received from the high-order driver with respect to the boot disk directed to the first driver to the second driver when detecting the end of initialization of the second driver.

According to the present invention, after finishing the initialization process of the second device driver, the disk access to the boot disk is executed by use of the second disk access system. The access to the boot disk can be thereby speeded up.

In the disk access system switching device according to a first mode, when receiving from the high-order driver a query command about whether there is the boot disk directed to the second device driver or not, the command can be, a command result “failure” about the command being generated, sent back to the high-order driver without transferring the command to the second device driver.

Further, in the disk access system switching device according to the first mode, when receiving from said high-order driver the disk access command with respect to the boot disk directed to said second device driver, the command can be, a command result “success” about the command being generated, sent back to said high-order driver without transferring the command to said second device driver.

Still further, according to the first mode, the first disk access system is an I/O emulation system, and the second disk access system is a para virtualization system.

A second mode of the present invention is a guest operating system capable of accessing an access target disk via a management operating system, comprising:

a first driver executing a disk access to a guest operating system boot disk by use of a first disk access system;

a second driver executing the disk access by use of a second disk access system capable of the disk access faster than by the first disk access system;

a high-order driver issuing disk access commands to the first and second drivers; and

a disk access system switching device interposed between the first and second device drivers and the high-order driver, transferring the disk access command received from the high-order driver with respect to the boot disk directed to the first driver to the first driver before an end of initializing the second driver, and transferring the disk access command received from the high-order driver with respect to the boot disk directed to the first driver to the second driver when detecting the end of initialization of the second driver.

Yet further, a third mode of the present invention is an information processing device comprising:

a physical disk:

a management operating system managing a disk access to the physical disk; and

a guest operating system issuing a disk access request corresponding to a self-provided virtual disk environment,

wherein the management operating system converts the disk access request corresponding to the virtual disk environment that is issued from the guest operating system into a disk access request corresponding to the physical disk, and accesses the physical disk, and

the guest operating system including:

a first driver executing a disk access to a virtual boot disk of the guest operating system by use of a first disk access system;

a second driver executing a virtual disk access by use of a second disk access system capable of the disk access faster than by the first disk access system;

a high-order driver issuing disk access commands to the first and second drivers; and

a disk access system switching device interposed between the first and second device drivers and the high-order driver, transferring the disk access command received from the high-order driver with respect to the boot disk directed to the first driver to the first driver before an end of initializing the second driver, and transferring the disk access command received from the high-order driver with respect to the boot disk directed to the first driver to the second driver when detecting the end of initialization of the second driver.

The present invention can be realized by way of the invention of a method such as a disk access switching method having the same features as those given in the first through third modes described above, or realized as a computer program for actualizing the first through third modes, or as a storage medium readable by a computer stored with the computer program.

According to the modes of the present invention the disk access to the boot disk can be speeded up.

### BRIEF DESCRIPITON OF THE DRAWINGS

FIG. 1 is a diagram showing an example of a configuration of an information processing device (computer) including a disk access system having

FIG. 2 is a conceptual diagram of an Xen-based platform (virtual OS environment) embracing a virtual disk driver developed on a memory illustrated in FIG. 1, showing a concept of the guest OS using disk access methods based on an I/O emulation system and a PV system, respectively.

FIG. 3 is a diagram of a table showing contents processed by a filter driver in response to a command sent toward a destination disk driver from a high-order driver.

FIG. 4 is a diagram showing a concept of a disk existence query command process by the filter driver.

FIG. 5 is a diagram showing a concept of a disk I/O command process by the filter driver.

FIG. 6A is an explanatory diagram showing an operation of the filter driver when booting (starting up) the guest OS.

FIG. 6B is an explanatory diagram showing the operation of the filter driver when booting (starting up) the guest OS.

FIG. 6C is an explanatory diagram showing the operation of the filter driver when booting (starting up) the guest OS.

FIG. 7 is a flowchart showing an operation example of a command process by the filter driver.

FIG. 8 is a diagram showing an example of a conventional disk access system.

### DETAILED DESCRIPTION OF THE PREFERRED EMBODIMENTS

An embodiment of the present invention will hereinafter be described with reference to the drawings. A configuration in the following embodiment is an exemplification, and the present invention is not limited to the configuration in the embodiment.

### Outline of Embodiment

A mechanism for filtering an access to a disk through a guest OS (domains 1, 2, 3, . . . ) is added to a virtual OS environment (e.g., an Xen-based virtualization platform (provided by XenSource Inc.)). This scheme enables performance of disk I/O to be improved by accessing in a way that switches over to a fast-accessible interface after booting the guest OS.

At an early stage of a boot process of Windows (registered trade mark) domain (the guest OS), immediately after loading a device driver of an I/O emulation system, a boot disk (Boot Disk) is accessed by use of this device driver. At a later stage of the boot process, however, after loading a PV system driver, the boot disk is accessed by using this device driver. With this scheme, the fast access based on the PV system to the boot disk can be realized.

Herein, the boot disk (Boot Disk) is a disk stored with a system file for starting up (booting) the system (at least the guest OS). The system file can contain not only the data used when booting but also the data employed as the necessity may arise after booting. A scheme of the embodiment is that in a boot process (Boot Process) of the guest OS, after completion of initializing the PV system driver, there occurs a status of having a disk access based on the PV system to the boot disk. Hence, in a virtual operating system which provides a virtual disk environment as by the guest OS, the performance of the disk I/O (disk input/output) can be improved.

In order to realize this improvement, when receiving an I/O request (a disk access request) from the guest OS, the I/O request is allocated to any one of the device driver based on the I/O emulation system and the device driver based on the PV system, corresponding to a status. A high-order device driver is prepared for these device drivers. A dynamic disk access switchover mechanism in this virtual environment is defined as a [virtual disk filter driver]. This scheme is actualized by switching over the I/O request allocation target driver to the PV system driver from the device driver based on the I/O emulation system with the virtual disk filter driver (corresponding to a disk access system switching device) while detecting load timing of the device driver in the course of the boot process.

[Specific Example]

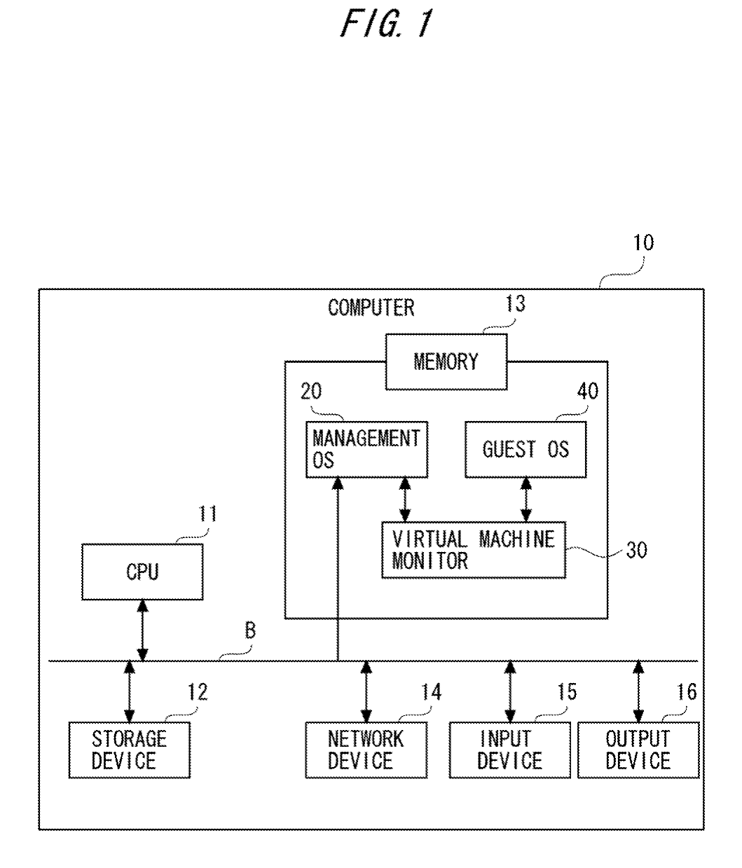

FIG. 1 is a diagram showing an example of a configuration of an information processing device (computer) provided with the disk access system including a management OS and the guest OS. In FIG. 1, a computer 10 includes a processor like a CPU 11, a storage device (e.g., a hard disk (HDD)) 12, a memory (e.g., RAM)) 13, a network device 14, an input device (e.g., a keyboard and a mouse) 15 and an output device (e.g., a display and a printer), which are connected to each other via a bus B. The CPU 11 executes programs, whereby a management OS 20, a virtual machine monitor 30 and a guest OS 40 are realized on the memory 13.

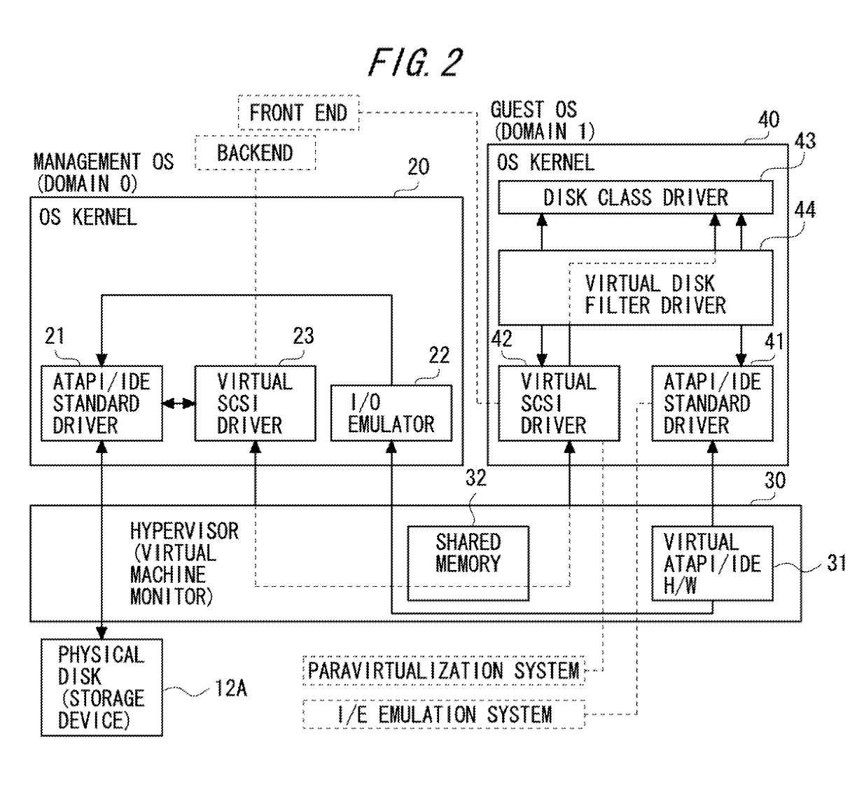

FIG. 2 is a conceptual diagram of an Xen (virtual OS) platform including the virtual disk driver developed on the memory 13, showing conceptually the guest OS 40 using the disk access methods based on the I/O emulation system and the PV system, respectively.

In FIG. 2, the management OS (domain 0) 20 includes an ATAPI (Advanced Technology Attachment Packet Interface)/IDE (Integrated Drive Electronics) standard driver 21 for accessing to a physical disk 12A, and an I/O emulator 22 for realizing the I/O emulation system. On the other hand, the management OS 20 includes a virtual SCSI (Small Computer System Interface) driver 23 for realizing the PV system.

The virtual machine monitor (hypervisor) 30 includes ATAPI/IDE hardware 31 serving as virtual hardware generated through emulation by the I/O emulator 22. The virtual machine monitor 30 exists for concealing the hardware (H/W) from the guest OS 40. The guest OS 40 I/O-accesses the management OS 20 without being aware of the hardware (e.g., the physical disk 12A), whereby the management OS 20 acting for the guest OS 40 controls (disk access control) the hardware (e.g., the physical disk 12A).

The guest OS (domain 1) 40 (virtual OS) includes an ATAPI/IDE standard driver 41 that supports the I/O emulation system, a virtual SCSI driver 42 that supports the PV system, and a disk class driver 43 defined as a high-order driver over these drivers 41 and 42, wherein a virtual filter driver 44 (which will hereinafter be simply referred to as a filter driver) is interposed between the drivers 41, 42 and the disk class driver 43.

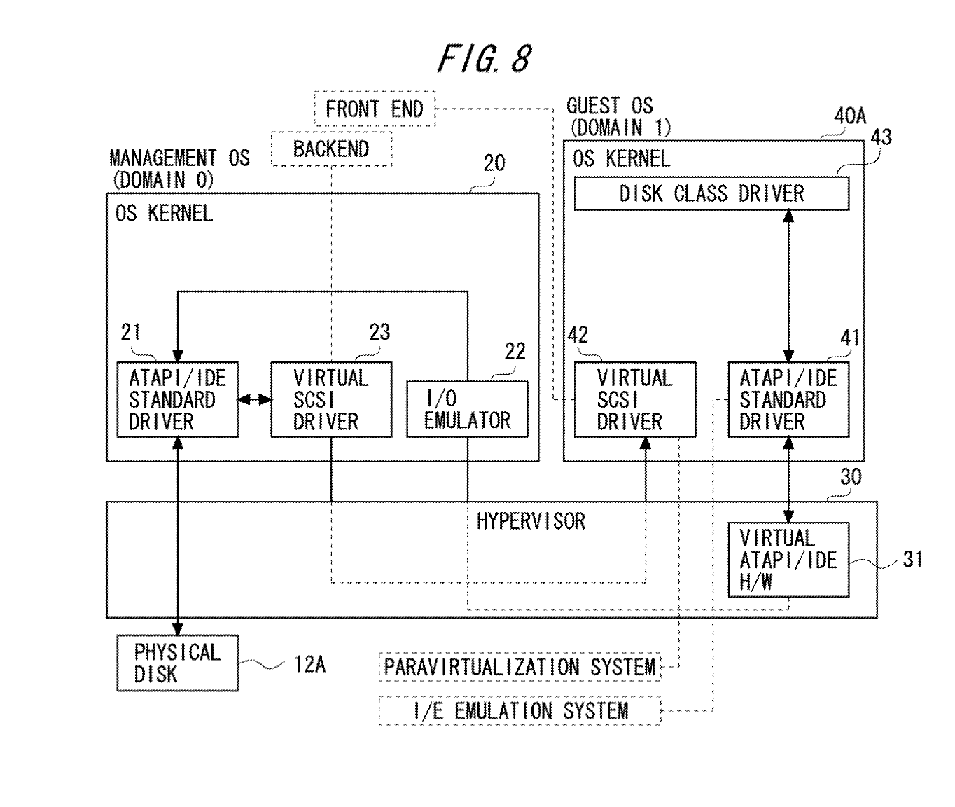

Thus, the configuration in the embodiment is, unlike FIG. 8, that the filter driver 44 exists between the disk class driver 43 and the device drivers 41, 42 which support the respective systems. The filter driver 44 can switch over the disc access system to the single disk (embraced by the physical disk 12A and the storage device 12) to between the I/O emulation system and the PV system, corresponding to the status.

In FIG. 1, the management OS (domain 0) 20 manages the guest OS 40 via the Xen Hypervisor (virtual machine monitor) 30. The Xen Hypervisor 30 interposed between the guest OS 40 and the hardware (H/W: physical disk 12A) is thereby enabled to generate the virtual H/W such as the virtual ATAPI/IDE hardware 31 and to associate the virtual hardware with the actual hardware.

The guest OS (domain 1) 40 sees the actual hardware (physical disk 12A) concealed by the Xen Hypervisor (virtual machine monitor) 30 and receives allocation of the virtual hardware (the guest OS 40 is provided with the virtual disk environment) from the management OS (domain) 20. Note that FIG. 2 exemplifies the single guest OS, however, a plurality of guest operating systems OS (domains 1, 2, 3, . . . ) may also exist.

The filter driver 44 performs a role of transferring the I/O request received from the disk class driver 43 to one proper driver of the device drivers (I/O emulation system and the PV system) 41 and 42, corresponding to a load status of the device drivers 41 and 42.

In the I/O emulation system, the Xen Hypervisor (virtual machine monitor) 30 emulates the actually-existing ATAPI/IDE hardware (H/W) circulating in the general public, thereby generating the virtual hardware such as the virtual ATAPI/IDE hardware 31. The guest OS 40 can execute an I/O command by utilizing the virtual hardware. Therefore, the guest OS 40 involves using the device driver as it is that is provided for the hardware circulating in the general public as the device driver based on the I/O emulation system. In the example shown in FIG. 2, the ATAPI/IDE standard driver 41 is employed.

The I/O request for the virtual hardware (virtual ATAPI/IDE/W31) is controlled from the management OS 20 and is converted, on the management OS 20, into the I/O request for the physical disk 12A by the I/O emulator 22 and by the ATAPI/IDE standard driver 21, whereby the access to the physical disk 12A is executed.

In the PV system, both of the guest OS 40 and the management OS 20 have the PV system based device drivers, and these device drivers are paired to process the I/O request while performing cooperative operations, and convert this I/O request into the I/O request for the physical disk 12A. The PV system based device driver held by the guest OS 40 is called a front-end driver, while the PV system based device driver held by the management OS 20 is called a backend driver. In the example in FIG. 2, the virtual SCSI driver 42 corresponds to the front-end driver, while the virtual SCSI driver 23 corresponds to the backend driver.

In the PV system, the actually-existing hardware is not emulated as by the I/O emulation system, and simply the I/O data is transferred and received by use of a shared memory 32 (e.g., a memory area is generated on the virtual machine monitor 30) accessible from both of the guest OS 40 and the management OS 20. The I/O data process is thereby simplified. The reception and the transfer of the I/O data are attained by the cooperative operations of the front-end driver (driver 42) and the backend driver (driver 23).

The filter driver 44 included in the guest OS 40 has mainly the following two functions.

(Function 1) A function 1 is capable of hooking a command given from a high-order entity (the disk class driver 43 (which is also called a high-order driver 43)) and flowing (transferring) the command to a different low-order disk driver (one of the drivers 41 and 42). At this time, the filter driver 44 may simply rewrite an address of the command and transfers the command itself in an as-is format.

(Function 2) A function 2 hooks the command given from the high-order entity (the high-order driver: disk class driver 43) and terminates the command without transferring the command to the target low-order disk driver (one of the drivers 41 and 42).

It is shown that the function 1 can hook, the filter driver 44 being ranked above the I/O emulation system based driver 41 and the PV system based driver 42, the command issued to the respective drivers 41 and 42 from the high-order driver 43.

The filter driver 44 hooks a disk I/O command given from the high-order driver 43 and enables a change of the target device drivers (drivers 41 and 42) given this I/O command. A user is not aware of the operation of this type of filter driver 44. Namely, the user has, in a user's operation (e.g., the operation of the input device 15), no necessity of being aware of the operation of the filter driver 44.

The function 2 shows that the filter driver 44 hooks a query command about the existence of the disk, which is given from the high-order driver 43, and terminates a response to this command. The existence of the disk can be concealed from the user by applying this function 2 in such a way that a disk status acquisition command gets into a failure and turns back.

<Explanation of Operation>

During the execution of the boot process of the guest OS 40 (e.g., Windows (registered trade mark)), the filter driver 44 monitors an initialization process of the PV system based driver 42. In this state, the boot disk (the virtual boot disk (in the virtual disk environment provided to the guest OS 40) as viewed from the guest OS 40) operates in the I/O emulation system using the driver 41. In this boot process, the driver 41 is loaded (initialized) in advance of loading (initializing) the driver 42. Therefore, the access to the boot disk when in the boot process involves using the I/O emulation system.

Next, upon completion of initializing the PV system based driver 42, the filter driver 44 hooks the disk I/O command directed to the I/O emulation system based driver 41 and flows the command to the PV system based driver 42. With this scheme, the PV system based driver 42 enables the fast access to the disk. Hence, the performance of the access to the boot disk is improved. Thus, the disk access can be switched over without the user's being aware of this operation.

The disk query command to the PV system based driver 42 from the high-order driver 43 is terminated and discarded by the filter driver 44. The boot disk via the PV system based driver 42 is, though existing, invisible to the user and becomes inoperable disk.

<Content of Hook of Virtual Disk Filter Driver>

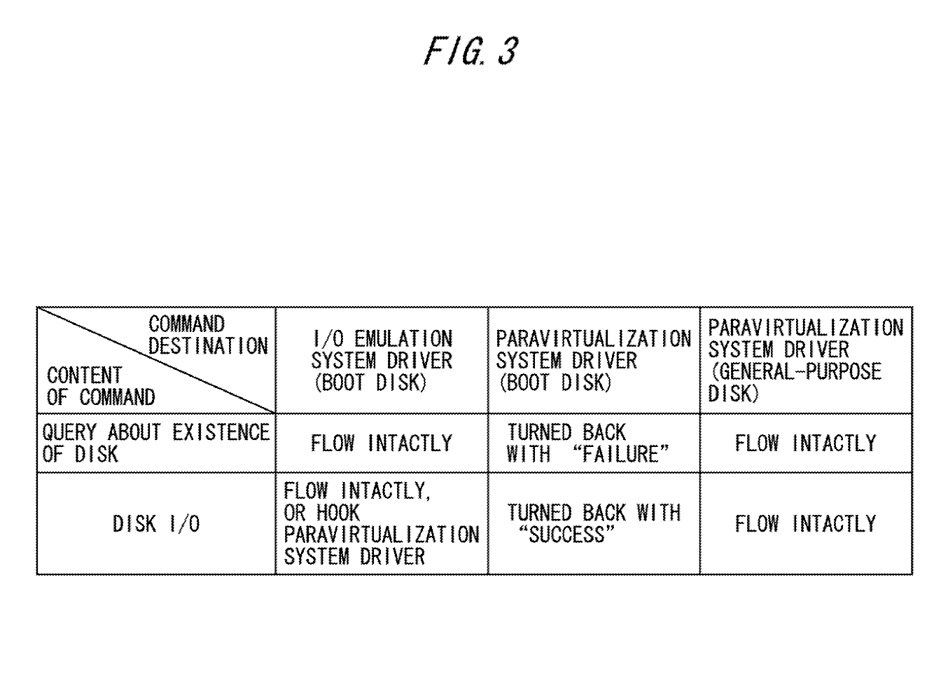

FIG. 3 is a table showing contents to be processed by the filter driver 44 about the commands sent to the destination disk driver from the high-order driver 43. The filter driver 44 flows commands other than the disk status acquisition command (disk existence query command) and the I/O command as hook targets to the low-order driver.

Normally, the filter driver 44 processes the command with respect to the I/O emulation system based driver 41 (boot disk) or the PV system based driver (general-purpose disk) 42.

If the filter driver 44 receives the command with respect to the PV system based driver 42 (boot disk), however, as described about the command in the table, the filter driver 44 executes the process of turning the command back to the high-order driver 43 due to a failure. This is because, supposing that this case occurs, a problem arises if the command is flowed as it is to the driver 42.

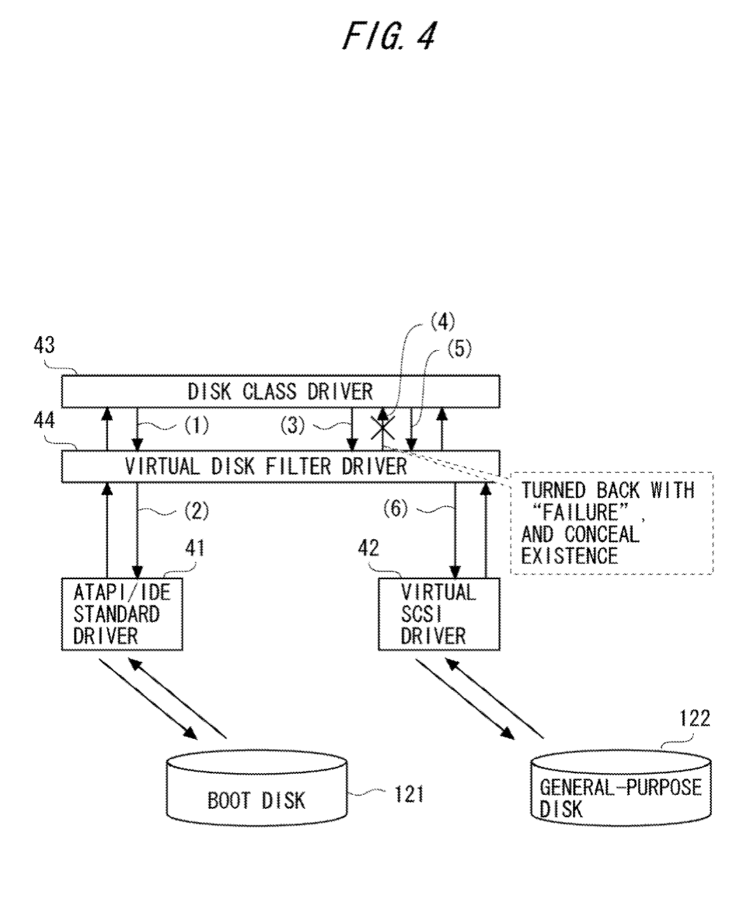

FIG. 4 shows a concept of the disk existence query command process by the filter driver 44. As shown in FIG. 4, when receiving the disk existence query command((1) in FIG. 4) with respect to the I/O emulation system based driver 41 from the high-order driver (disk class driver) 43, the filter driver 44 flows the command as it is to the driver 41 ((2) in FIG. 4).

By contrast, the filter driver 44 executes a process corresponding to the access target disk about the disk existence query command with respect to the PV system based driver 42. To be specific, if a boot disk 121 receives the access target disk existence query command ((3) in FIG. 4), the filter driver 44 terminates the command, sets a result of the access to the “failure” and turns the command back to the high-order driver 43 ((4) FIG. 4). This scheme intends to prevent the boot disk from being dually visible to the user.

In contrast with this process, when receiving the disk existence query command ((5) in FIG. 4) in the case of the general-purpose disk 122 being the access target disk, the filter driver 44 flows the disk existence query command about the general-purpose disk 122 directly to the driver 42 ((6) in FIG. 4).

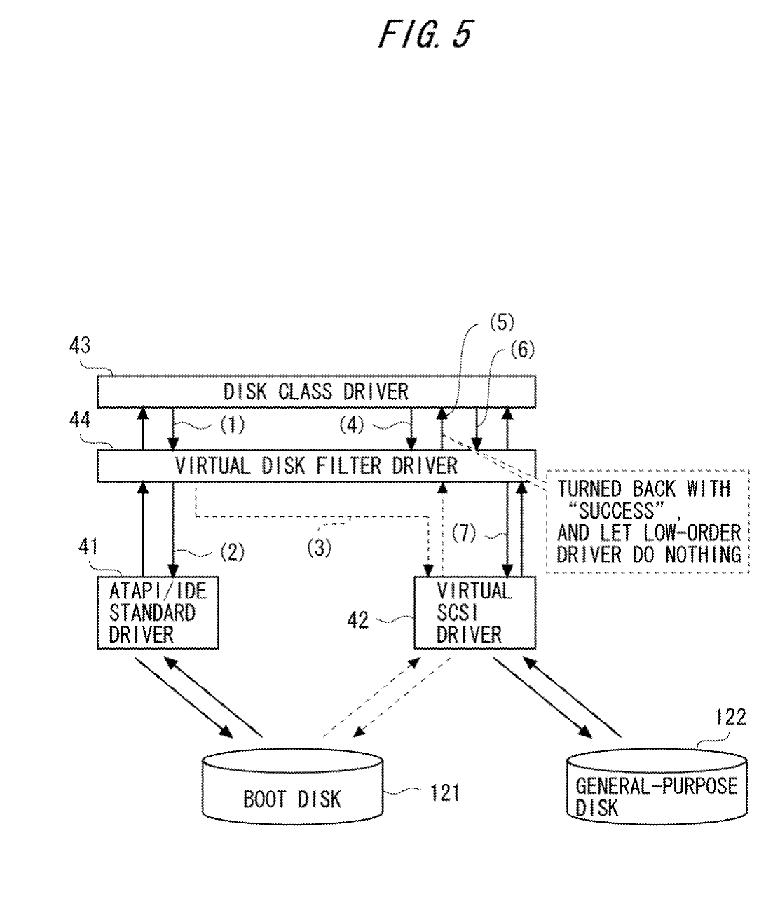

FIG. 5 shows a concept of a disk I/O command process by the filter driver 44. At a start of booting the guest OS 40, the high-order driver (disk class driver) 43 flows the disk access command (disk I/O command (1) in FIG. 5) to the I/O emulation system based driver 41 ((2) in FIG. 5).

After booting and after completing the initialization of the PV system based driver 42, when receiving, from the high-order driver 43, the disk I/O command ((1) in FIG. 5) to the boot disk 121 directed to the driver 41, the disk I/O command is hooked at the PV system based driver 42 ((3) in FIG. 5).

On the other hand, the disk I/O command ((4) in FIG. 5 to the boot disk 121 with respect to the PV system based driver 42 is, if “successful”, turned back to the high-order driver 43 ((5) FIG. 5). This intends to prevent data mismatching from occurring due to the access to the boot disk 121 simultaneously (in parallel) with the I/O emulation system based driver 41. By contrast, the filter driver 44 does nothing about the disk access command (disk I/O command: (6) in FIG. 5) to the general-purpose disk 122 with respect to the driver 42, and flows this command to the driver 42 ((7) in FIG. 5).

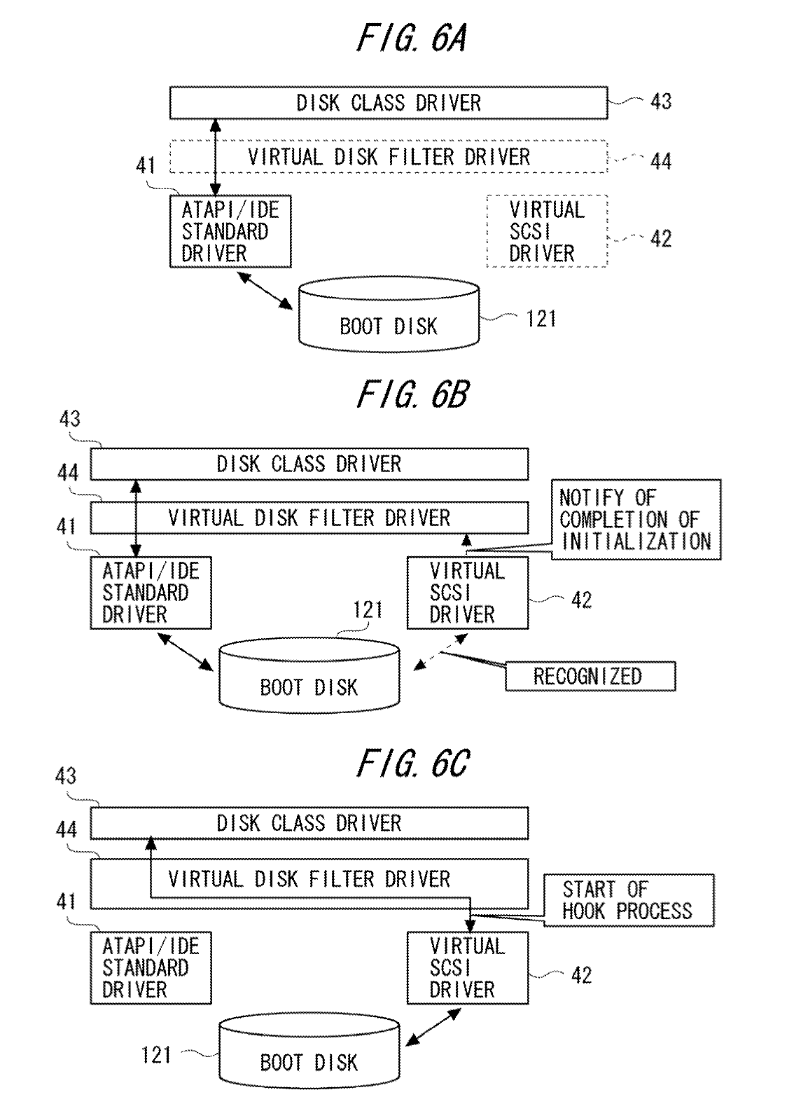

FIGS. 6A, 6B and 6C are explanatory diagrams of the operation of the filter driver 44 when booting (starting up) the guest OS 40. When booting the guest OS, the I/O command is hooked at the PV system based driver 42 from the I/O emulation system based driver 41 according to the following flow.

As shown in FIG. 6A, at first, the high-order driver 43 boots the guest OS 40 with the driver 41 (I/O emulation system) (the driver 43 accesses the boot disk 121 by use of the driver 41). At this time, neither the filter driver 44 nor the driver 42 (PV system) is loaded.

Next, as shown in FIG. 6B, the filter driver 44 and the driver 42 are loaded from the guest OS 40. The filter driver 44 waits for the completion of initializing the driver 42. The driver 42, when recognizing the boot disk 121 with the initialization, transfers completion-of-initialization notification to the filter driver 44.

Subsequently, as shown in FIG. 6C, the filter driver 44, upon receiving the completion-of-initialization notification from the driver 42, starts a process (hook process) of hooking the disk I/O command directed to the driver 41 and transferring the command to the driver 42. With this process, after finishing the initialization of the driver 42, the boot disk 121 is accessed by use of the PV system based driver 42.

<Command Processing Operation by Filter Driver>

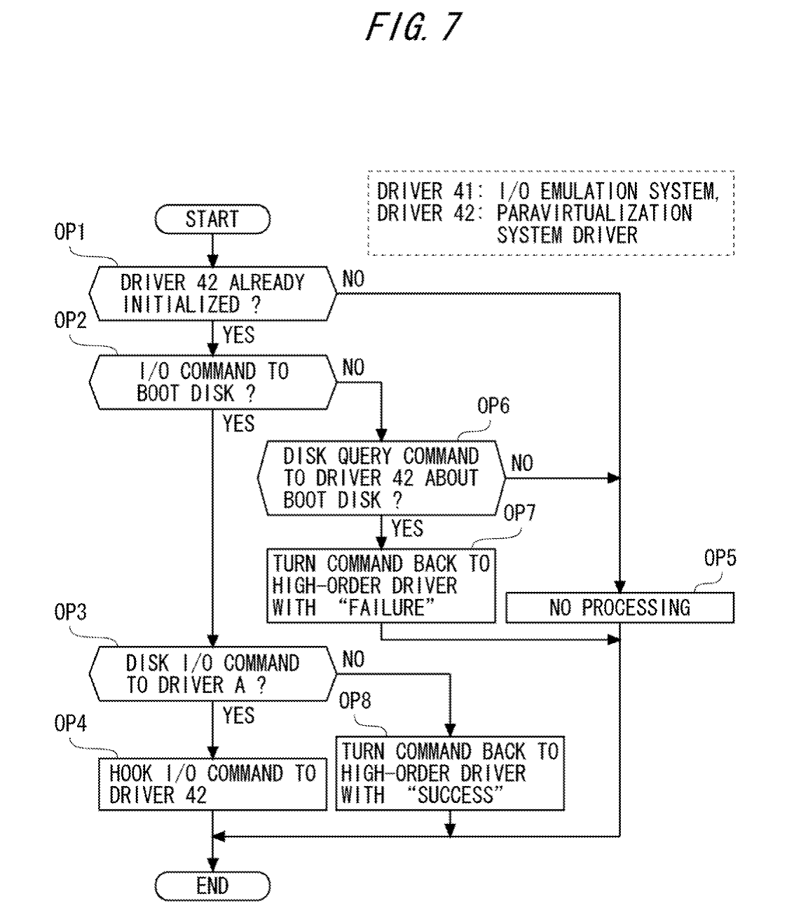

FIG. 7 is a flowchart showing an example of a command processing operation by the filter driver 44. The process shown in FIG. 7 starts, e.g., when initiating the OS boot and after an end of loading the filter driver 44.

At first OP 1, the filter driver 44, each time the driver 44 receives the disk access command (disk I/O command), checks whether the initialization of the PV system based driver 42 is completed or not.

In the case of completing the initialization (OP 1; YES), the filter driver 44 starts the hook process of the disk I/O command, and executes a process predetermined by a content of the command given from the high-order driver 43 (the process according to the table in FIG. 3 is executed).

Specifically, the filter driver 44 determines whether or not the command from the high-order driver 43 is the disk I/O command to the boot disk 121 (OP 2). If the command from the high-order driver 43 is not the disk I/O command (OP 2; NO), the processing proceeds to OP 6. Whereas if the command is the disk I/O command (OP 2; YES), the processing proceeds to OP 3.

In OP 3, the filter driver 44 determines whether or not the disk I/O command is the disk I/O command to the I/O emulation system based driver 41. If the command is not the disk I/O command to the driver 41 (OP 3; NO), the processing proceeds to OP 8 and, where as if the command is the disk I/O command to the driver 41) OP 3; YES), the processing proceeds to OP 4.

In OP 4, the filter driver 44 hooks the I/O command, then rewrites an address of this command to the driver 42 and supplies this command to the driver 42. Thereafter, the processing comes to an end.

If the processing proceeds to OP 5, the filter driver 44 transfers the command to the I/O emulation system based driver 41 without executing none of the processes for the command. Thereafter, the processing is finished.

Further, if the processing proceeds to OP 6, the filter driver 44 determines whether or not the command is the disk existence query command of the boot disk 121 with respect to the driver B. At this time, if the command is the disk existence query command of the boot disk 121 (OP 6; YES), this command is terminated, a result “failure” about this command is generated, and the command is turned back to the high-order driver 43 (OP 7). By contrast, if the command is not the disk existence query command of the boot disk 121 (OP 6; NO, i.e., if the command is the disk existence query command of the general-purpose disk 122), the processing proceeds to OP 5, and the filter driver 44 transfers the command to the driver 42 without executing the process for the command.

Further, if the processing proceeds to OP 8, it is assumed that the command is the disk I/O command to the boot disk 121 directed to the driver 42, the filter driver 44 terminates the command, and turns, after generating a result “success” for the command, this command back to the high-order driver 43. Thereafter, the processing is finished.

When finishing the flowchart, the filter driver 44 comes to a standby status for a next command coming from the high-order driver 43, and executes the processes from OP 1 onward upon receiving the next command.

### Effect in Embodiment

According to the embodiment, the boot disk 121 can be switched over to the PV system from the I/O emulation system during the boot process of the guest OS. The following problems in terms of the performance are thereby solved.

(1) The time expended for booting the system is reduced. Friendliness to the system user is thereby improved by the fast system boot. Moreover, the fast system boot actualizes a system recovery at an early stage when rebooting the system if a trouble occurs.

(2) After booting, there is increased performance when normally operated. Namely, the boot disk is accessed based on the PV system. It is therefore feasible to execute the application at the high speed, increase a degree of multiplicity of the user accesses, improve the system performance such as the fast response in the network and improve the friendliness to the system user.

(3) A memory dump output is speeded up. Namely, if a fault occurs in the system, a content of the memory is written to a file (e.g., a system file) in the boot disk. A problem of requiring a tremendous quantity of time for the memory dump output (the content of the memory is written to the file) is solved by using the PV system. Hence, when the system is crashed down, the system recovery at the early stage is actualized.

What is claimed is:

1. A disk access system switching device interposed between a first driver executing a disk access to an operating system boot disk by use of a first disk access system, a second driver executing the disk access by use of a second disk access system capable of the disk access faster than by said first disk access system, and a high-order driver issuing disk access commands to said first and second drivers,
wherein said disk access system switching device transfers the disk access command received from said high-order driver with respect to the boot disk directed to said first driver to said first driver before an end of initializing said second driver, and transfers the disk access command received from said high-order driver with respect to the boot disk directed to said first driver to said second driver when detecting the end of initialization of said second driver.

2. A disk access system switching device according to claim 1, wherein when receiving from said high-order driver a query command about whether there is the boot disk directed to said second device driver or not, the command is, a command result “failure” about the command being generated, sent back to said high-order driver without transferring the command to said second device driver.

3. A disk access system switching device according to claim 1, wherein when receiving from said high-order driver the disk access command with respect to the boot disk directed to said second device driver, the command is, a command result “success” about the command being generated, sent back to said high-order driver without transferring the command to said second device driver.

4. A disk access system switching device according to claim 1, wherein said first disk access system is an I/O emulation system, and
said second disk access system is a para virtualization system.

5. An information processing device comprising:
a physical disk;
a management operating system managing a disk access to said physical disk; and
a guest operating system issuing a disk access request corresponding to a self-provided virtual disk environment,
wherein said management operating system converts the disk access request corresponding to the virtual disk environment that is issued from said guest operating system into a disk access request corresponding to said physical disk, and accesses said physical disk, and
said guest operating system including:
a first driver executing a disk access to a virtual boot disk of said guest operating system by use of a first disk access system;
a second driver executing a virtual disk access by use of a second disk access system capable of the disk access faster than by said first disk access system;
a high-order driver issuing disk access commands to said first and second drivers; and
a disk access system switching device interposed between said first and second device drivers and said high-order driver, transferring the disk access command received from said high-order driver with respect to the boot disk directed to said first driver to said first driver before an end of initializing said second driver, and transferring the disk access command received from said high-order driver with respect to the boot disk directed to said first driver to said second driver when detecting the end of initialization of said second driver.

6. A storage medium readable by a computer, stored with a program making a computer function as a disk access system switching device interposed between a first driver executing a disk access to an operating system boot disk by use of a first disk access system, a second driver executing the disk access by use of a second disk access system capable of the disk access faster than by said first disk access system, and a high-order driver issuing disk access commands to said first and second drivers, said program making said computer execute:
a step of transferring the disk access command received from said high-order driver with respect to the boot disk directed to said first driver to said first driver before an end of initializing said second driver; and
a step of transferring the disk access command received from said high-order driver with respect to the boot disk directed to said first driver to said second driver when detecting the end of initialization of said second driver.
